(19) United States
(12) Patent Application Publication
(10) Pub. No.: US 2024/0141542 A1
(43) Pub. Date: May 2, 2024

(54) Growth of Nanowires

(71) Applicant: NanoWired GmbH, Gernsheim (DE)

(72) Inventors: Olav Birlem, Gernsheim (DE); Florian Dassinger, Gernsheim (DE); Sebastian Quednau, Gernsheim (DE); Farough Roustaie, Gernsheim (DE)

(21) Appl. No.: 18/279,122

(22) PCT Filed: Feb. 22, 2022
(86) PCT No.: PCT/EP2022/054381

§ 371 Date: Aug. 28, 2023

(30) Foreign Application Priority Data
Mar. 3, 2021 (DE) 10 2021 105 125.8

(51) Int. Cl. C25D 17/06; C25D 7/00

(52) U.S. Cl. CPC C25D 17/06; C25D 7/006

(57) ABSTRACT

Method for galvanically growing a plurality of nanowires on a substrate, comprising
a) placing a foil onto the surface, the foil having a plurality of passing-through pores, in which the nanowires can be grown from an electrolyte,
b) placing an elastic element that is permeable to the electrolyte onto the foil, the electrolyte being brought into contact with the foil by way of the elastic element,
c) for a first growing time period, galvanically growing the plurality of nanowires,
d) removing the elastic element, and
e) for a second growing time period, continuing the galvanic growing of the plurality of nanowires.

The invention relates to the galvanic growing of nanowires. In particular, the invention relates to a method and an arrangement for providing a plurality of nanowires on a surface.

Methods and arrangements with which nanowires can be produced are known. For example, nanowires can be obtained by galvanic processes or by means of methods that are known from thin-film technology. It is common to many known methods that they require complex machines, and in particular for this reason are usually only used (can only be used) in laboratories and in clean rooms. In particular, most known methods are not suitable for industrial use.

Also, many known arrangements and methods have the disadvantage that the nanowires obtained vary greatly in their properties, and in particular with respect to their quality. The nanowires from different growing processes often differ, sometimes considerably, even if the same machines, starting materials and/or formulations are used. The quality of nanowires often depends in particular on the ability of the user of a corresponding arrangement or the user of a corresponding method, on environmental influences and also simply on chance. All of this is made more difficult by the fact that nanowires are structures which sometimes cannot even be seen with an optical microscope. Therefore, elaborate investigations are necessary to make it possible in the first place to ascertain the described properties (and in particular the fluctuations in them).

In particular on account of the described differences in quality, it is often not possible with known methods and arrangements to grow nanowires on larger surface areas. It is therefore probable that the nanowires differ with respect to their properties between different regions of a larger surface area on which they are grown. This may be disadvantageous for many applications.

On this basis, the object of the invention is to provide a method and an arrangement with which a plurality of nanowires can be produced with particularly consistent quality.

This object is achieved by the arrangement and the method according to the independent claims. Further advantageous configurations are indicated in the dependent claims. The features represented in the claims and in the description can be combined with one another in any technologically meaningful way.

According to the invention, a method for galvanically growing a plurality of nanowires onto a surface is provided. The method comprises:
a) placing a foil onto the surface, the foil having a plurality of passing-through pores, in which the nanowires can be grown from an electrolyte,
b) placing an elastic element that is permeable to the electrolyte onto the foil, the electrolyte being brought into contact with the foil by way of the elastic element,
c) for a first growing time period, galvanically growing the plurality of nanowires,
d) removing the elastic element, and
e) for a second growing time period, continuing the galvanic growing of the plurality of nanowires.

Steps a) and b) can be carried out in any desired sequence one after the other or entirely or partially overlapping. Steps c) to e) are carried out after steps a) and b), in the sequence given.

With the method described, nanowires can be produced. A nanowire is understood here as meaning any body of material that has a wire-like form and a size in the range of a few nanometres to a few micrometres. A nanowire may for example have a circular, oval or polygonal base area. In particular, a nanowire may have a hexagonal base area.

The nanowires preferably have a length in the range from 100 nm [nanometres] to 100 [micrometres], in particular in the range from 500 nm to 60 μm. The nanowires also preferably have a diameter in the range from 10 nm to 10 μm, in particular in the range from 30 nm to 2 μm. Here, the term diameter relates to a circular base area, a comparable definition of a diameter being applicable if the base area deviates from this. It is particularly preferred that all of the nanowires used have the same length and the same diameter.

The described method can be used for a wide variety of materials of the nanowires. Electrically conducting materials, in particular metals such as copper, silver, gold, nickel, tin and platinum, are preferred as the material of the nanowires. However, non-conducting materials, such as metal oxides, are also preferred. Preferably, all of the nanowires are formed from the same material.

The surface onto which the nanowires are to be grown is preferably made to be electrically conducting. If the surface is part of a body that is otherwise not electrically conducting (such as for example a substrate), the electrical conductivity can be achieved for example by a metallization. Thus, for example, a substrate that is not electrically conducting may be coated with a thin layer of metal. The metallization can be used in particular to produce an electrode layer. Depending on the material of the surface and/or the electrode layer, it may be advisable to provide a bonding layer between the surface and the electrode layer that imparts an adhesive bond between the surface and the electrode layer.

The electrical conductivity of the surface allows it to be used as an electrode for the galvanic growing of the nanowires. The substrate may be in particular a silicon substrate. The surface may be in particular the surface of a body which is provided with electrically conducting structures. It may be in particular a silicon chip or a so-called printed circuit board (PCB).

With the method described, the nanowires can be galvanically grown onto the surface in pores of a foil. An electrolyte is used for this. The nanowires can be provided in a particularly consistent quality if, during the growing, the foil lies closely against the surface and the electrolyte is evenly distributed over the foil. This is achieved in the case of the method described by the growing being divided into two steps. In a first growing step, an elastic element lies against the foil, by which the foil is held on the surface. The elastic element is permeable to the electrolyte, so that the electrolyte can be released onto the foil by way of the elastic element. In the first growing step, the nanowires are grown to the extent that the foil is held on the surface by the nanowires. In the second growing step, the elastic element is no longer required. The elastic element is therefore removed, whereby the electrolyte can be distributed even more evenly over the surface.

In step a), the foil is placed onto the surface to be grown on. The foil is preferably formed by a plastics material, in particular by a polymer material. In particular, it is preferred that the foil is connected to the surface in such a way that the foil does not slip. This could reduce the quality of the nanowires grown.

The foil has a plurality of passing-through pores, in which the nanowires can be grown. The pores are preferably made to pass through the foil by being formed by channels which pass through from an upper side of the foil to an underside of the foil. In particular, it is preferred that the pores are made to be cylindrical. However, it is also possible that the pores are made as channels following a curved path. A pore may have for example a circular, oval or polygonal base area. In particular, a pore may have a hexagonal base area. The pores are preferably formed uniformly (i.e. the pores preferably do not differ with respect to the size, shape, arrangement and/or distance from adjacent pores). When the nanowires are being grown in steps c) and d), the pores are preferably filled (in particular completely) with the galvanically deposited material. This makes the nanowires take on the size, shape and arrangement of the pores. The properties of the nanowires to be grown can therefore be established or influenced by the choice of the foil or pores. The foil may therefore also be referred to as a “template”, “template foil” or “pattern”.

In step b), an elastic element that is permeable to the electrolyte is placed onto the foil. The elastic element is preferably designed to release an electrolyte at least at one delivery point. The delivery point is preferably made to cover a surface area, it being particularly preferred that the electrolyte can be released uniformly over a delivery area. It is also preferred that the elastic element completely covers the foil. For example, the elastic element may be a sponge or a cloth. The elastic element is preferably designed in such a way that it can additionally bring about fixing of the foil. This may be accomplished in particular by the means for providing the electrolyte being made to cover a surface area and designed for pressing the foil against the surface.

In steps c) and e), the nanowires are grown. This initially takes place according to step c) in a first growing process. For this, an electrical voltage is applied between the surface to be grown on and an electrode. Both the surface and the electrode are in contact with the electrolyte. Thus, the nanowires are grown from the electrolyte onto the surface, into the pores of the foil. During the first growing time period, the elastic element rests on the foil. This can prevent the foil from slipping. In the first growing time period, the nanowires are formed to such an extent that the nanowires hold the foil. The elastic element is subsequently superfluous. It is therefore removed in step d). For the duration of step d), the applied electrical voltage may be switched off, so that the growing is to this extent interrupted. It is, however, also conceivable that the growing is continued uninterrupted, so that growing also takes place in step d). The first growing time period and the second growing time period are in this case only separated from each other by the elastic element being removed between these two steps. In step e), the growing of the nanowires is continued for a second growing time period. This takes place in principle as in step c), but without the elastic element. In step e), therefore, no elastic element lies against the foil. The electrolyte can in this case come into contact with the surface directly. This makes it easier for the electrolyte to be supplied to the surface. It can therefore be achieved more easily that there is at any time sufficient electrolyte at all points of the surface. If this were not the case, no growing of the nanowires would take place at the respective point in spite of an applied electrical voltage. This could impair the quality of the nanowires obtained.

The first growing time period preferably has a length that is at least 10% of a length of the second growing time period, preferably at least 50% of the length of the second growing time period.

The length of the first growing time period and the length of the second growing time period may be fixed. Alternatively preferred is the embodiment of the method in which a transferred charge is determined from an electrical current used for galvanically growing the nanowires in step c), with step c) being ended when the transferred charge has reached a predetermined limit value.

In this embodiment, the length of the first growing time period is variable. Step c) is ended as soon as the growing of the nanowires has progressed to the extent that the nanowires can hold the foil without the elastic element. The progress of the growing of the nanowires is in this case not measured directly. Instead, the charge transferred during the galvanic growing is determined. This is a measure of how many atoms were converted according to the galvanic growth. The transferred charge can be determined by temporal integration from the electrical current used for the galvanic growing of the nanowires. If the current intensity is constant, the charge is obtained by multiplication of the current intensity by the time. The electrical current used for the galvanic growing of the nanowires is the electron current that flows between the surface and the electrode.

In the present embodiment, step c) is ended when the transferred charge has reached a predetermined limit value. A suitable limit value can be determined by tests. The limit value is preferably chosen in such a way that, after the completion of step c), the foil is held on the surface to the desired extent by the nanowires.

In a further preferred embodiment of the method, the elastic element is pressed onto the foil in step c).

Pressing the elastic element against the foil can make it easier to provide the electrolyte. For example, the electrolyte can be induced to leave a sponge by pressing the sponge. A spring is preferably provided for the pressing, the force with which the spring presses the elastic element against the foil being adjustable. Elastic or plastic devices, motorized, hydraulic and/or pneumatic adjusting units or lever mechanisms may also be used for producing the pressing force. The amount of electrolyte that is delivered can be controlled by adjusting the force. Furthermore, the elastic element is used for pressing the foil onto the surface, so that the foil is held with a form fit, fixed in place and free from air inclusions (between the foil and the surface and in the pores within the foil).

That the elastic element is pressed onto the foil in step c) means that the elastic element is pressed onto the foil at least during part of step c). Preferably, the elastic element is pressed against the foil over the entire duration of step c).

In the present embodiment, the elastic element is pressed onto the foil to the extent that the elastic element is pressed onto the foil with a force that exceeds the weight of the elastic element. The elastic element's own weight is therefore not sufficient for it to be pressed on as provided in the present embodiment. As an alternative to the present embodiment, the elastic element may rest on the foil, without being pressed against the foil, for the entire duration of step c).

In a further preferred embodiment of the method, the elastic element is lifted off from the foil by means of a gripper in step d).

With the gripper, the elastic element can be removed from the foil in an automated manner. This allows the entire method to be carried out in an automated manner, whereby errors can be avoided. The gripper may for example be formed as a needle gripper.

As a further aspect of the invention, an arrangement for galvanically growing a plurality of nanowires is provided. The arrangement comprises:
a surface onto which the nanowires are to be grown,
a foil placed onto the surface, the foil having a plurality of passing-through pores, in which the nanowires can be grown from an electrolyte,
an elastic element that is placed onto the foil and is permeable to the electrolyte, it being possible for the electrolyte to be brought into contact with the foil by way of the elastic element,
a gripper for removing the elastic element from the foil.

The advantages and features of the method can be applied and transferred to the arrangement, and vice versa. The method is preferably carried out with the arrangement. The arrangement is preferably intended and designed for being operated according to the described method.

In a preferred embodiment, the arrangement also comprises a control unit, which is designed for carrying out at least steps c) to e) of the method. The control unit is designed to carry out the method to the extent to which the method is automated. Thus, the control unit may for example control the galvanic growing by an electrical voltage that is required for the galvanic growing being controlled by the control unit. The pressing of the elastic element against the foil may be controlled in step c) by the control unit to the extent that the elastic element is for example pressed against the foil by means of a hydraulic ram. Such a ram may be controlled by the control unit. If steps a) and/or b) are also carried out in an automated manner, they may also be controlled by the control unit.

The arrangement preferably has a housing inside which all elements of the arrangement are arranged. The housing preferably has a receptacle for a drawer. An object with the surface to be grown on, with the foil placed on it and the elastic element placed on top, may be inserted into the drawer and pushed with the latter into the receptacle. To this extent, the object with the surface to be grown on and the foil placed on it and the elastic element placed on top may be arranged inside the housing. By being arranged in a housing, a particularly user-friendly machine with which the nanowires can be grown is obtained.

In a further preferred embodiment, the arrangement also comprises a drive for actuating the gripper in an automated manner

With the drive, step d) can be carried out in an automated manner The drive may for example be designed to bring the gripper into contact with the elastic element in step d), to grip the elastic element and/or to lift it off from the surface. With the drive, therefore the position of the gripper can be changed and/or the gripper can be actuated. Actuating the gripper should be understood as meaning that the elastic element can be gripped with the gripper and released again. The gripper may for example be a needle gripper.

In a further preferred embodiment, the arrangement also comprises a movable rest for the elastic element.

In step d), the elastic element may be gripped with the gripper and lifted off from the surface. Subsequently, the movable rest may be pushed between the surface and the elastic element. The elastic element may be placed onto the movable rest and released by the gripper. Subsequently, the elastic element may be transported away with the movable rest. Subsequently, the elastic element may be removed from the movable rest. This may take place in an automated manner, for example by the movable rest being moved in such a way that, from a separating point, the elastic element can no longer follow the movement of the movable element. The separating point may for example be obtained as a result of the movable rest being guided into a rest receptacle that does not provide any space for the elastic element. The elastic element in this case is left hanging on the edge of the rest receptacle. The elastic element may be deposited in a compartment, from which the elastic element can be manually removed.

The movable rest may be moved in an automated manner, for example by a motor. The movable rest is preferably formed from a flexible material, for example from plastic. Thus, the movable rest can be stowed in a space-saving manner when it is not required. For example, the movable rest may be guided by way of a deflecting roller, so that, when it is not required, the movable rest can be stowed in a position turned by 90° with respect to the surface.

In a further preferred embodiment, the arrangement also has a cleaning device for cleaning the movable rest.

The cleaning device is preferably designed to spray a cleaning fluid onto the movable rest. This may take place for example after the elastic element has been transported away with the movable rest and has been removed from it. The cleaning device is preferably arranged in such a way that in step d) the movable rest is guided past the cleaning device once the elastic element has been removed from the movable rest.

In a further preferred embodiment, the arrangement also comprises a voltage source, which is connected to an electrode and the surface for applying an electrical voltage for the growing of the nanowires.

The voltage source serves for providing the electrical current required for the galvanic growing. The voltage source is preferably designed to generate a pulsed voltage, in particular with a pulse frequency in the range from 0.1 to 10 ms. It has been shown by tests that, with a pulsed voltage, the quality of the nanowires can be improved.

In a further preferred embodiment, the arrangement also has a reference electrode, which is connected to the surface.

With the reference electrode, the growing of the nanowires can be monitored. For this, the voltage between the electrode and the reference electrode can be measured with the reference electrode. The arrangement may comprise one or more reference electrodes.

The electrode is preferably connected to the voltage source by way of a first cable. The surface to be grown on is preferably connected to the voltage source by way of a second cable. The reference electrode is preferably connected to a voltmeter by way of a third cable. The surface is preferably connected to the voltmeter by a fourth cable, in particular independently of the second cable. The second cable and the fourth cable are preferably connected in each case directly to the surface. For this, the surface may have a respective contact pad, by way of which the second cable and the fourth cable are connected to the surface, for example by means of a respective conducting tape. The reference electrode is therefore not simply connected to the surface by the reference electrode being connected to a branching of the second cable. It has been found that, by comparison, a direct attachment of the reference electrode to the surface produces more accurate results.

The object with the surface to be grown on and the reference electrode are preferably arranged in the drawer.

The first cable, the second cable, the third cable and the fourth cable may in each case be divided into a number of portions, which are connected to one another for example by way of plug-in connections. The second cable, the third cable and/or the fourth cable may in each case be divided into portions in such a way that a respective transition between two adjacent portions of the corresponding cable is arranged at an edge of the drawer. The drawer may have a corresponding connector for each of these three cables. Thus, electrical contact between the surface and the reference electrode may be made when the drawer is pushed into the receptacle by the three plug-in connections being formed. The voltmeter and the voltage source are preferably arranged inside the housing and outside the receptacle for the drawer.

In a further preferred embodiment, the arrangement also comprises an (in particular electrically driven) mangle for squeezing out the electrolyte from the elastic element when the elastic element has been removed from the foil with the gripper.

The mangle may have two rollers, between which the elastic element is moved through. In this case, a pressure can be exerted on the elastic element by the rollers, so that the elastic element releases electrolyte that is present in the elastic element. In this way, a considerable part of the electrolyte can be removed from the elastic element and re-used.

The invention is explained in more detail below on the basis of the figures. The figures show a particularly preferred exemplary embodiment, to which the invention is not restricted however. The figures and the relative sizes shown therein are only schematic. In the figures:

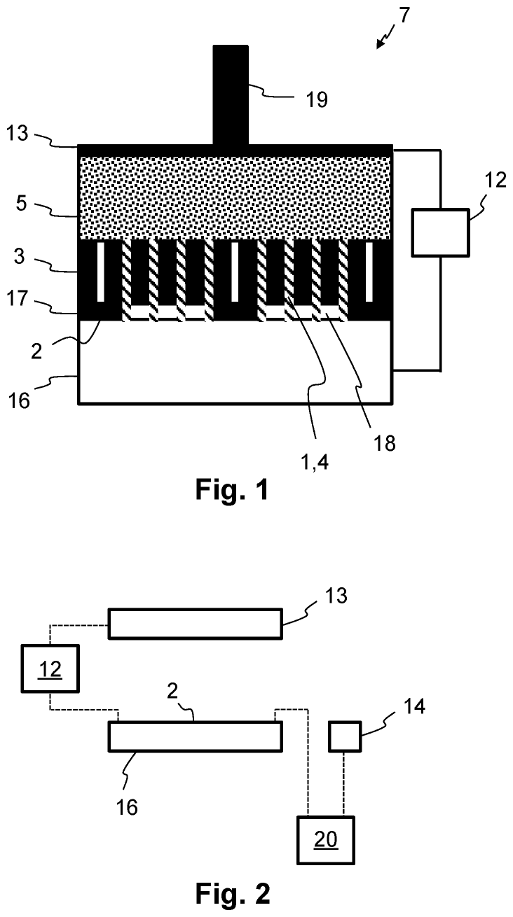

FIG. 1: shows an arrangement according to the invention for galvanically growing a plurality of nanowires,

FIG. 2: shows a connection of a reference electrode for the arrangement from FIG. 1,

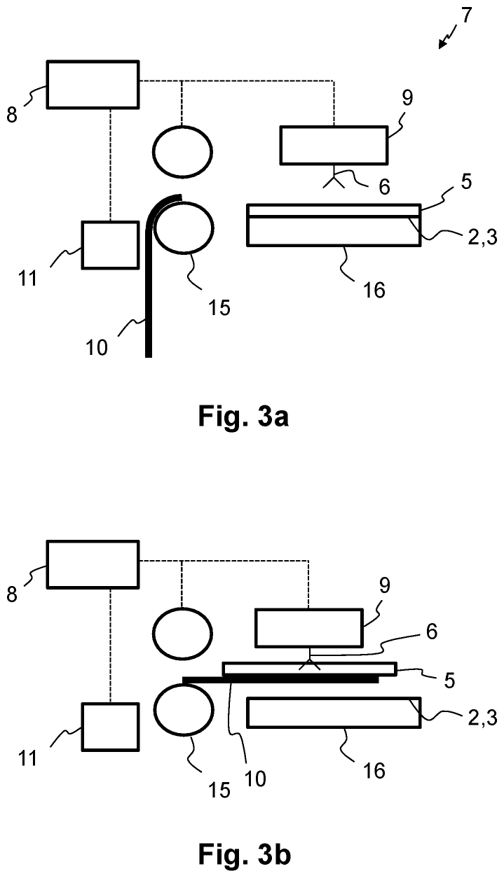

FIGS. 3a and 3b: show further elements of the arrangement from FIG. 1 in two different states.

FIG. 1 shows an arrangement 7 for galvanically growing a plurality of nanowires 1. The arrangement 7 comprises a substrate 16 with a surface 2 onto which the nanowires 1 are to be grown. The arrangement 7 also comprises a foil 3, which has a plurality of passing-through pores 4, in which the nanowires 1 can be grown from an electrolyte, and has been placed onto the surface 2. The surface 2 has a structuring layer 17 with clearances 18. The nanowires 1 can only be grown in the clearances 18. Thus, the growing of the nanowires 1 can take place locally selectively. Furthermore, the arrangement 7 comprises an elastic element 5 that is permeable to the electrolyte and has been placed onto the foil 3. The electrolyte can be brought into contact with the foil 3 by way of the elastic element 5. The arrangement 7 also comprises a voltage source 12, which is connected to an electrode 13 and the surface 2 for applying an electrical voltage for the growing of the nanowires 1. The voltage source 12 is also connected to the control unit 8. The electrode 13 may be pressed against the elastic element 5 with a ram 19.

The arrangement 7 is not completely shown in FIG. 1. Further elements are shown in FIGS. 2, 3a and 3b.

FIG. 2 shows further elements of the arrangement 7 from FIG. 1. For the sake of overall clarity, not all of the elements from FIG. 1 are shown in FIG. 2. Thus, along with the voltage source 12, the electrode 13 and the substrate 16 with the surface 2, the arrangement 7 also has a reference electrode 14. The reference electrode 14 is connected to the surface 2 by way of a voltmeter 20. The voltage source 12 and the reference electrode 14 are attached to the surface 2 independently of one another.

FIGS. 3a and 3b show further elements of the arrangement 7 from FIGS. 1 and 2. For the sake of overall clarity, not all of the elements from FIGS. 1 and 2 are shown in FIGS. 3a and 3b. It can be seen from FIGS. 3a and 3b in particular that the arrangement 7 has a gripper 6 for removing the elastic element 5 from the foil 3. FIG. 3a shows the state in which the elastic element 5 on the foil 3 rests on the surface 2 of the substrate 16. The elastic element 5 may be gripped with the gripper 6 and lifted off from the surface 2. This is shown in FIG. 3b. Since the elastic element 5 no longer rests on the foil 3 in FIG. 3b, to this extent an arrangement 7 according to the invention is no longer shown in FIG. 3b. The arrangement 7 comprises a drive 9 for actuating the gripper 6 in an automated manner. Moreover, the arrangement 7 comprises a movable rest 10 for the elastic element 5. In FIG. 3a, the movable rest 10 is stowed in a position turned by 90° with respect to the surface 2 because the movable rest 10 is not required in the state shown. In FIG. 3b, the movable rest 10 has been pushed between the surface 2 and the elastic element 5. In this way, the elastic element 5 can be placed onto the movable rest 10. Subsequently, the elastic element 5 can be transported away with the movable rest 10 by the movable rest 10 being moved back into its state shown in FIG. 3a. The elastic element 5 can come away from the movable rest 10 for example by the elastic element 5 not following the downward movement of the movable rest 10. As soon as the elastic element 5 has come away from the movable rest 10, the movable rest 10 can be cleaned with a cleaning device 11. For this, the movable rest 10 can be sprayed with a cleaning fluid by the cleaning device 11. The arrangement 7 also has an electrically driven mangle 15 for squeezing out the electrolyte from the elastic element 5 when the elastic element 5 has been removed from the foil 3 with the gripper 6. The mangle 15 has two rollers, between which the elastic element 5 can be moved through under the effect of a force.

The arrangement 7 also comprises a control unit 8, which is designed for carrying out steps c) to e) of the following method:
a) placing a foil 3 onto the surface 2, the foil 3 having a plurality of passing-through pores 4, in which the nanowires 1 can be grown from an electrolyte,
b) placing an elastic element 5 that is permeable to the electrolyte onto the foil 3, the electrolyte being brought into contact with the foil 3 by way of the elastic element 5,
c) for a first growing time period, galvanically growing the plurality of nanowires 1, with the elastic element 5 being pressed onto the foil 3,
d) removing the elastic element 5 by the elastic element 5 being lifted off from the foil 3 by means of a gripper 6, and
e) for a second growing time period, continuing the galvanic growing of the plurality of nanowires 1.

In step c), a transferred charge is determined from the electrical current used for galvanically growing the nanowires 1, with step c) being ended when the transferred charge has reached a predetermined limit value.

### LIST OF REFERENCE SIGNS

1 Nanowire
2 Surface
3 Foil
4 Pore
5 Elastic element
6 Gripper
7 Arrangement
8 Control unit
9 Drive
10 Movable rest
11 Cleaning device
12 Voltage source
13 Electrode
14 Reference electrode
15 Mangle
16 Substrate
17 Structuring layer
18 Clearance
19 Ram
20 Voltmeter

1. Method for galvanically growing a plurality of nanowires onto a substrate, comprising
a) placing a foil onto the surface, the foil having a plurality of passing-through pores, in which the nanowires can be grown from an electrolyte,
b) placing an elastic element that is permeable to the electrolyte onto the foil, the electrolyte being brought into contact with the foil by way of the elastic element,
c) for a first growing time period, galvanically growing the plurality of nanowires,
d) removing the elastic element, and
e) for a second growing time period, continuing the galvanic growing of the plurality of nanowires.

2. Method according to claim 1, wherein a transferred charge is determined from an electrical current used for galvanically growing the nanowires in step c), and wherein step c) is ended when the transferred charge has reached a predetermined limit value.

3. Method according to claim 1, wherein the elastic element is pressed onto the foil in step c).

4. Method according to claim 1, wherein the elastic element is lifted off from the foil by means of a gripper in step d).

5. Arrangement for galvanically growing a plurality of nanowires, comprising:
a surface onto which the nanowires are to be grown,
a foil placed onto the surface, the foil having a plurality of passing-through pores, in which the nanowires can be grown from an electrolyte,
an elastic element that is placed onto the foil and is permeable to the electrolyte, it being possible for the electrolyte to be brought into contact with the foil by way of the elastic element,
a gripper for removing the elastic element from the foil.

6. Arrangement for galvanically growing a plurality of nanowires, comprising:
a surface onto which the nanowires are to be grown,
a foil placed onto the surface, the foil having a plurality of passing-through pores, in which the nanowires can be grown from an electrolyte,
an elastic element that is placed onto the foil and is permeable to the electrolyte, it being possible for the electrolyte to be brought into contact with the foil by way of the elastic element,
a gripper for removing the elastic element from the foil, which is designed for carrying out steps c) to e) of a method according to claim 1.

7. Arrangement according to claim 5, also comprising a drive for actuating the gripper in an automated manner.

8. Arrangement according to claim 5, also comprising a movable rest for the elastic element.

9. Arrangement according to claim 8, also comprising a cleaning device for cleaning the movable rest.

10. Arrangement according to claim 5, also comprising a voltage source, which is connected to an electrode and the surface for applying an electrical voltage for the growing of the nanowires.

11. Arrangement according to claim 10, also comprising a reference electrode, which is connected to the surface.

12. Arrangement according to claim 5, also comprising a mangle for squeezing out the electrolyte from the elastic element when the elastic element has been removed from the foil with the gripper.
